(19) United States
(12) Patent Application Publication
(10) Pub. No.: US 2008/0133498 A1
(43) Pub. Date: Jun. 5, 2008

(54) Search Category Commercialization Index

(75) Inventor: Kavel Patel, Sunnyvale, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/567,145

(22) Filed: Dec. 5, 2006

(51) Int. Cl. G06F 7/00

(52) U.S. Cl. 707/5

(57) ABSTRACT

A search category commercialization index (SCCI) may be calculated to determine the current and/or potential commercialization of a category of searches in a search engine. This may be accomplished by measuring two or more metrics from the group consisting of: number of searches within the category; number of searches within the category that result in results pages having sponsored search results; number of total advertisers in the category; average number of sponsored search listings for results pages in the category; click-through rate for advertisements in the category; share of sponsored search results that are clicked versus other items that are clicked on results pages in the category; average price per click on a sponsored search result advertisement; and lifetime value of users who perform searches within the category. The SCCI may be calculated based on the two or more metrics and then may be compared to SCCIs for other categories in the search engine.

### BACKGROUND OF THE INVENTION

1. Field of the Invention

The present invention relates to the field of Internet searching. More specifically, the present invention relates to a search category commercialization index.

2. Description of the Related Art

When searching for results in an Internet search engine or directory, it is common for advertisements to be displayed on the web page displaying the results of the search. FIG. 1 is a screen capture illustrating a search for the terms “iPod,” “nano”, “white,” and “buy.” As can be seen, ads 100 may be displayed above the search results 102. The ads 100 displayed above search results are often called “North” ads. Ads 104 may also be displayed below the search results 102. These ads 104 are often called “South” ads. “East” ads 106 may be displayed to the right of the search results 102. Search results 102 are sometimes called “natural” or “algorithmic” results.

Search queries can also be categorized into one or more categories. This is especially common in search engines that double as Internet directories. The category or categories often reflect groupings of similar web destinations based on subject matter.

Advertisers tend to place their advertisements based on specific search term combinations. However, the commercialization of the search category within which the keywords lie, i.e. how well a category translates into income (e.g., sales) for the advertisers, is of prime importance in convincing advertisers to place advertisements for various search combinations. In the past, however, measurement of the commercialization of a category was limited to very crude metrics, such as the number of searches conducted in the category.

### SUMMARY OF THE INVENTION

A search category commercialization index (SCCI) may be calculated to determine the current and/or potential commercialization of a category of searches in a search engine. This may be accomplished by measuring two or more metrics from the group consisting of: number of searches within the category; number of searches within the category that result in results pages having sponsored search results; number of total advertisers in the category; average number of sponsored search listings for results pages in the category; click-through rate for advertisements in the category; share of sponsored search results that are clicked versus other items that are clicked on results pages in the category; average price per click on a sponsored search result advertisement; and lifetime value of users who perform searches within the category. The SCCI may be calculated based on the two or more metrics and then may be compared to SCCIs for other categories in the search engine.

### BRIEF DESCRIPTION OF THE DRAWINGS

FIG. 1 is a screen capture illustrating a search for the terms “iPod” and “white.”

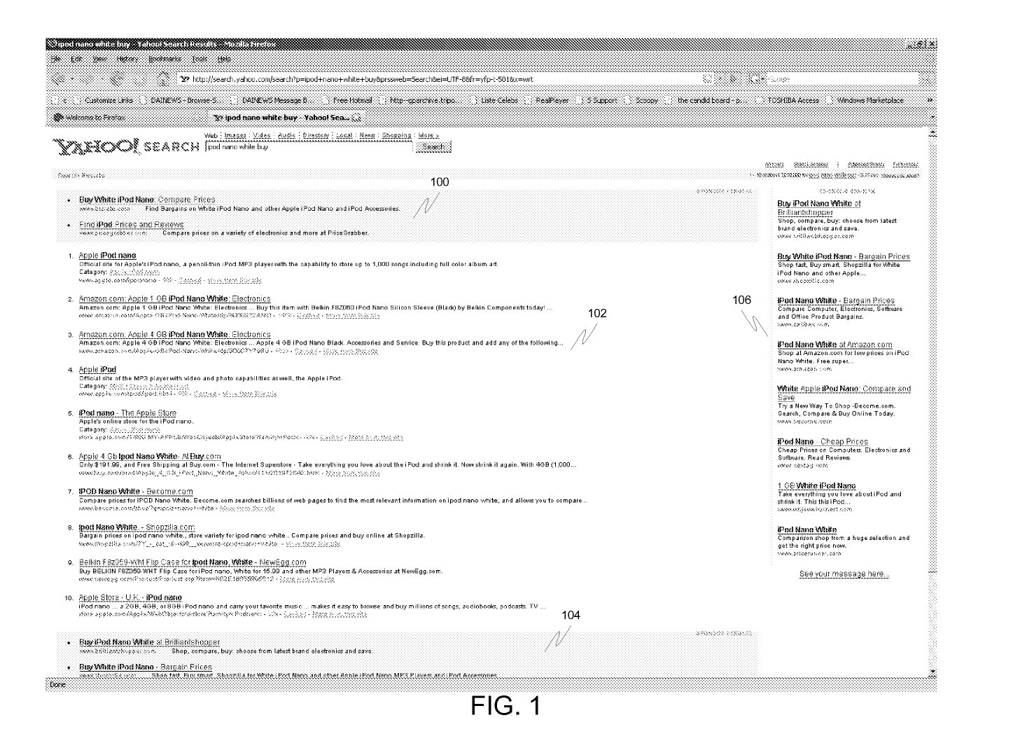

FIG. 2 is a graph of SCCIs versus volume of searches for a particular category.

FIG. 3 is a flow diagram illustrating a method for determining the current and/or potential commercialization potential of a category of searches in a search engine in accordance with an embodiment of the present invention.

FIG. 4 is a flow diagram illustrating a method for determining the current and/or potential commercialization potential of a category of searches in a search engine in accordance with an embodiment of the present invention.

FIG. 5 is an exemplary network diagram illustrating some of the platforms which may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

During the inventive process surrounding the present invention, a significant amount of research was conducted to measure the usage patterns of users performing searchers, and specifically patterns involving their clicks on sponsored search advertisements. In this research, it was unexpectedly discovered that there are several metrics that may be monitored that aid in the determination of how well a category commercializes. In this research, it was unexpectedly discovered that light users have the best likelihood of clicking on advertising, while searching for certain categories on the search results page. It was also unexpectedly discovered that a significant proportion of light user activity has no coverage. In other words, it was unexpectedly discovered that a significantly large volume of search queries that resulted in pages with no coverage were potentially the most valuable type of search query. This realization resulted in approaching the problem from a completely new perspective—i.e., from the user perspective and how likely it is for a user's behavior to turn to eventually reward the advertiser's choice to advertise in the category by making some purchase.

As such, a number of metrics may be combined to arrive at a search category commercialization index for a category of an Internet search engine. These metrics may be mixed and matched in various embodiments. However, in one embodiment all of the metrics are used in compiling the index. In some embodiments weightings may be applied to the metrics, making certain metrics more important than other metrics in computing the overall index. Furthermore, in some embodiments, the metrics may be measured in relation to similar metrics for other categories (i.e., relative amount as opposed to absolute amount).

One metric may be the number of searches within the category. There may be several different ways to measure this. In one embodiment, this may involve simply looking at the total number of searches since the category was first created. Another embodiment may involve looking at the total number of searches over a designated period of time (e.g., 6 months). The latter may be helpful in embodiments where this metric for this category is measured in relation to other categories, as it is possible that one of the categories compared may skew the results if it was created long before or long after the others. Additionally, the tastes of users may change over time, thus in certain categories newer results may be more relevant. For example, there may not have been a significant number of searches in the category of “MP3 Players” until iPods were released.

Another metric may be the coverage in this category. Coverage refers to the number of searches that result in results pages having sponsored search results (i.e. ads based on the search terms). This metric may therefore measure the number of searches in the category that result in results pages having sponsored search results. In one embodiment, the number of searches refers to the actual number of searches performed by all users, irrespective of duplications. Therefore, if thousands of people searched the term “iPod,” which resulted in search pages having sponsored search results, then that would ad thousands of positive results to the total number. This metric may also be expressed as a percentage of total searches in the category that resulted in results pages having sponsored search results.

Another metric may be the amount of North coverage. This may be a part of the total coverage metric described above or may be a stand-alone metric looking at the number of searches in the category that result in results pages having sponsored search results at the top of the results pages.

Another metric may be advertiser participation in the category, namely the number of total advertisers in the category. The more advertisers, the more commercial and competitive the category space is. However, due to increased cannibalization of clicks, it is less likely for any particular user to purchase items from any particular one of them due to the fact that a user may disregard a particular advertiser to select to purchase a similar item from another advertiser.

Another metric may be the average number of sponsored search listings within the category. In other words, the number of advertisements that typically show up on a search page in this category.

Another metric may be the average click-through rate for advertisements in this category. In one embodiment, this click-through rate may be weighted based on the placement of the advertisements, as North advertisements are more likely to have higher click-though rates than South advertisements, for example. Therefore, the average click-through rate for the category may not be a true average but rather a weighted average with North advertisements having higher relevance.

Another metric may be the share of sponsored search results that are clicked on versus other items that are clicked on. The other items may include, most prominently, natural search results, but may also include other links such as links to related searches and other areas of the search engine.

Another metric may be the average price per click on a sponsored search result advertisements. This is a key metric for measuring true commercialization since the average price per click can vary significantly between categories (e.g., between Entertainment and Finance). Therefore, adding a category-specific average price per click will enable a more accurate measurement of the SCCI.

Another metric may be the lifetime value of the searcher. This value may be based on many different criteria, such as whether the user is a long-time searcher, the frequency of searches, and seasonal patterns. For example, a user who performs the majority of his searches at the end of the calendar year may very well be more valuable to advertisers than a user who spreads the searches out over the year, as it appears that the user may be more likely to be using searches to find items to purchase for Christmas.

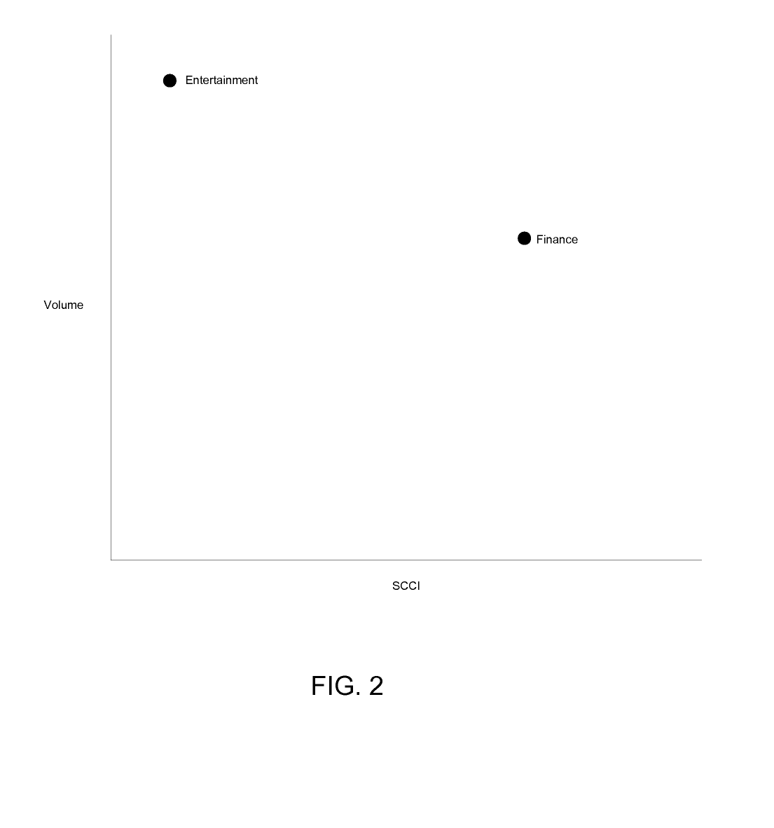

The search category commercialization index may be utilized in a number of ways to commercialize categories. In one embodiment, the search category commercialization index (SCCI) for different categories may be plotted on a graph having volume of searches on one axis and the SCCI on the other. An example of this is depicted in FIG. 2. This allows the search engine itself to take any number of different actions to use this information to gain profit. For example, the search engine may then undertake to attempt to convert users who search the “Entertainment” category into searches who search the “Finance” category, for example by sending emails to them informing them of new financial services or placing non-sponsored links to various finance portions of the search engine.

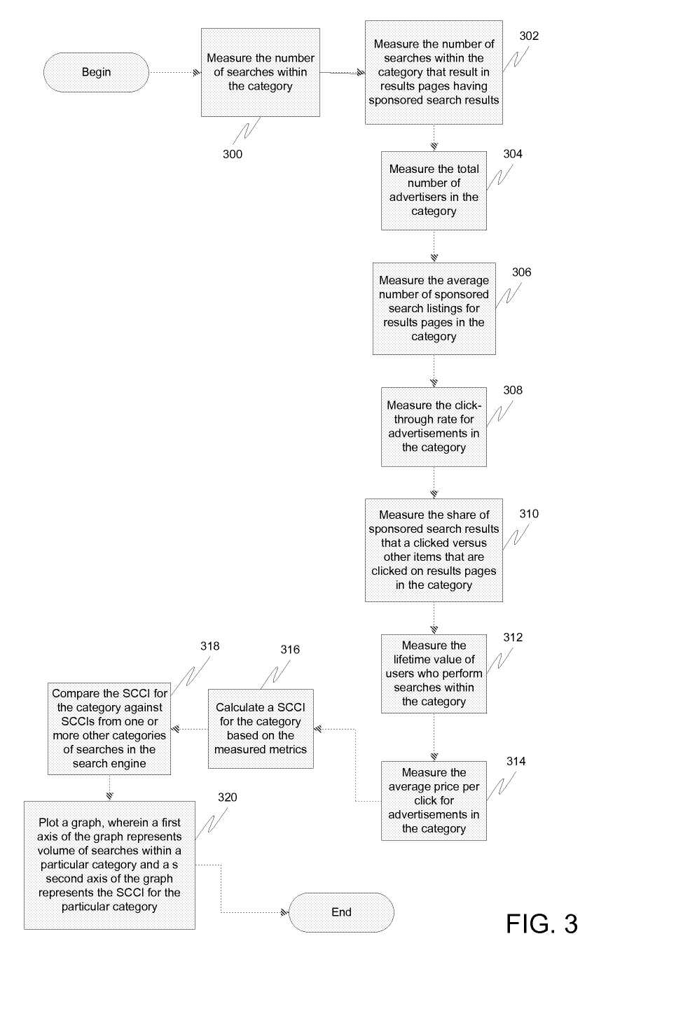

FIG. 3 is a flow diagram illustrating a method for determining the current and/or potential commercialization of a category of searches in a search engine in accordance with an embodiment of the present invention. At 300, the number of searches within the category may be measured. This may include the number of searches within the category over a designated period of time. At 302, the number of searches within the category that result in results pages having sponsored search results may be measured. This may be calculated irrespective of duplicate searches. At 304, the number of total advertisers in the category may be measured. At 306, the average number of sponsored search listings for results pages in the category may be measured. At 308, the click-through rate for advertisements in the category may be measured. This may be a weighted average of click-through rates for advertisements in the category, wherein advertisements in prominent positions on results pages are weighted heavier than advertisements in less prominent positions. At 310, the share of sponsored search results that are clicked versus other items that are clicked on results pages in the category may be measured. At 312, the average price per click for advertisements in the category may be measured. At 314, the lifetime value of users who perform searches within the category may be measured.

At 316, a search category commercialization index (SCCI) may be calculated for the category based on the measured metrics. This may include applying a weight to each of the metrics. Then at 318, the SCCI for the category may be compared against SCCIs from one or more other categories of searches in the search engine. At 320, a graph may be plotted, wherein a first axis of the graph represents volume of searches within a particular category and a second axis of the graph represents the SCCI.

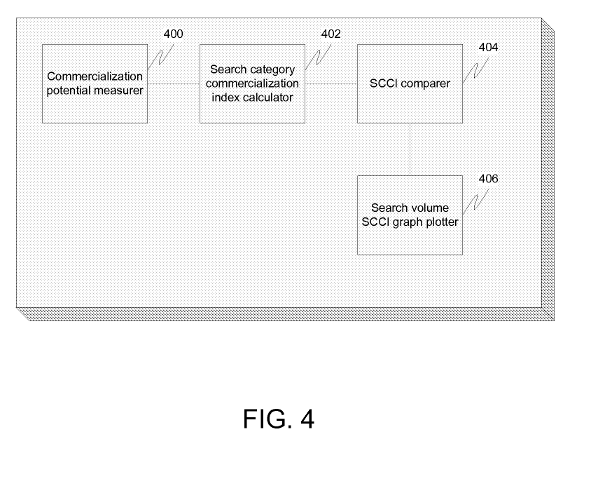

FIG. 4 is a flow diagram illustrating a method for determining the current and/or potential commercialization of a category of searches in a search engine in accordance with an embodiment of the present invention. A commercialization potential measurer 400 may measure a number of different metrics for the category. The number of searches within the category may be measured. This may include the number of searches within the category over a designated period of time. The number of searches within the category that result in results pages having sponsored search results may also be measured. This may be calculated irrespective of duplicate searches. The number of total advertisers in the category may also be measured. The average number of sponsored search listings for results pages in the category may also be measured. The click-through rate for advertisements in the category may also be measured. This may be a weighted average of click-through rates for advertisements in the category, wherein advertisements in prominent positions on results pages are weighted heavier than advertisements in less prominent positions. The share of sponsored search results that are clicked versus other items that are clicked on results pages in the category may also be measured. The lifetime value of users who perform searches within the category may also be measured.

A search category commercialization index calculator 402 coupled to the commercialization potential measurer 400 may calculate a search category commercialization index (SCCI) for the category based on the measured metrics. This may include applying a weight to each of the metrics. An SCCI comparer 404 coupled to the search category commercialization index calculator 402 may compare the SCCI for the category against SCCIs from one or more other categories of searches in the search engine. A search volume SCCI graph plotter 406 coupled to the SCCI comparer 404 may plot a graph, wherein a first axis of the graph represents volume of searches within a particular category and a second axis of the graph represents the SCCI.

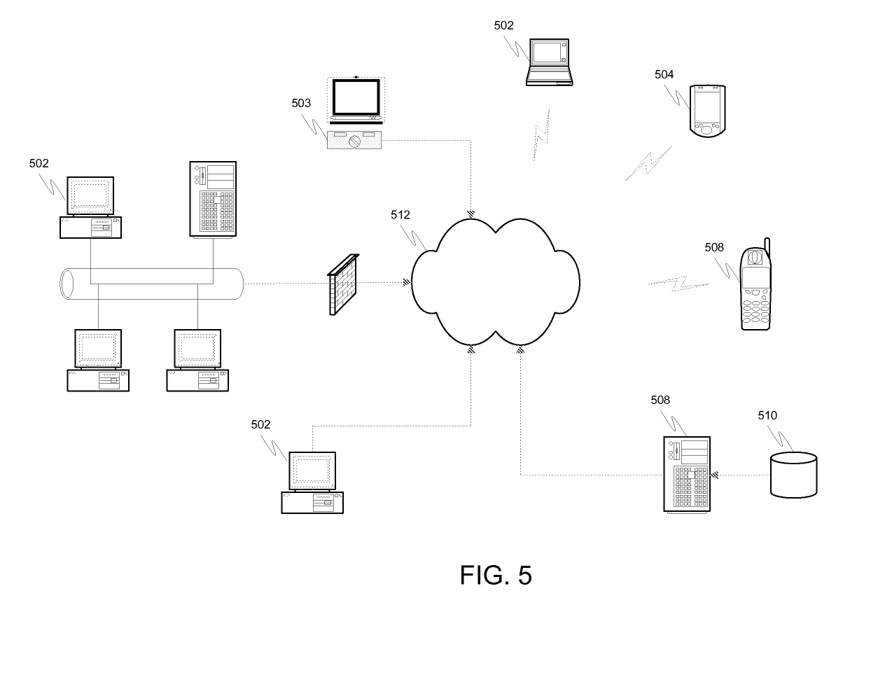

It should also be noted that the present invention may be implemented on any computing platform and in any network topology in which search categorization is a useful functionality. For example and as illustrated in FIG. 5, implementations are contemplated in which the categorization index functionality described herein is employed in a network containing personal computers 502, media computing platforms 503 (e.g., cable and satellite set top boxes with navigation and recording capabilities (e.g., Tivo)), handheld computing devices (e.g., PDAs) 504, cell phones 506, or any other type of portable communication platform. Users of these devices may conduction searches, which are then transmitted to server 508. Server 508 may then utilize the SCCI information in determining various different activities to take with respect to the user. As discussed above, applications may be resident on such devices, e.g., as part of a browser or other application, or be served up from a remote site, e.g., in a Web page, (represented by server 508 and data store 510). The invention may also be practiced in a wide variety of network environments (represented by network 512), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for determining the current and/or potential commercialization of a category of searches in a search engine, the method comprising:
measuring two or more of the metrics from the group consisting of:
number of searches within the category;
number of searches within the category that result in results pages having sponsored search results;
number of total advertisers in the category;
average number of sponsored search listings for results pages in the category;
click-through rate for advertisements in the category;
share of sponsored search results that are clicked versus other items that are clicked on results pages in the category;
average price per click on a sponsored search result advertisement in the category; and
lifetime value of users who perform searches within the category;
calculating a search category commercialization index (SCCI) for the category based on the two or more measured metrics; and
comparing the SCCI for the category against SCCIs from one or more other categories of searches in the search engine.

2. The method of claim 1, wherein number of searches within the category is the total number of searches within the category over a designated period of time.

3. The method of claim 1, wherein number of searches within the category that result in results pages having sponsored search results is calculated irrespective of duplicate searches.

4. The method of claim 1, wherein click-through rate for advertisements in the category is a weighted average of click-though rates for advertisements in the category, wherein advertisements in prominent positions on results pages are weighted heavier than advertisements in less prominent positions.

5. The method of claim 1, wherein the calculating includes applying a weight to each of the two or more measured metrics.

6. The method of claim 1, further comprising:
plotting a graph, wherein a first axis of the graph represents volume of searches within a particular category and a second axis of the graph represents the SCCI for a particular category.

7. An apparatus for determining the current and/or potential commercialization of a category of searches in a search engine, the apparatus comprising:
a commercialization potential measurer configured to measure two or more of the metrics from the group consisting of:
number of searches within the category;
number of searches within the category that result in results pages having sponsored search results;
number of total advertisers in the category;
average number of sponsored search listings for results pages in the category;
click-through rate for advertisements in the category;
share of sponsored search results that are clicked versus other items that are clicked on results pages in the category;
average price per click on a sponsored search result advertisement in the category; and
lifetime value of users who perform searches within the category;
a search category commercialization index calculator coupled to the commercialization potential measurer and configured to calculate a search category commercialization index (SCCI) for the category based on the two or more measured metrics; and
an SCCI comparer coupled to the search category commercialization index calculator and configured to compare the SCCI for the category against SCCIs from one or more other categories of searches in the search engine.

8. The apparatus of claim 7, wherein number of searches within the category is the total number of searches within the category over a designated period of time.

9. The apparatus of claim 7, wherein number of searches within the category that result in results pages having sponsored search results is calculated irrespective of duplicate searches.

10. The apparatus of claim 7, wherein click-through rate for advertisements in the category is a weighted average of click-though rates for advertisements in the category, wherein advertisements in prominent positions on results pages are weighted heavier than advertisements in less prominent positions.

11. The apparatus of claim 7, wherein the calculating includes applying a weight to each of the two or more measured metrics.

12. The apparatus of claim 7, further comprising:
a search volume SCCI graph plotter coupled to the SCCI comparer and configured to plot a graph, wherein a first axis of the graph represents volume of searches within a particular category and a second axis of the graph represents the SCCI for a particular category.

13. An apparatus for determining the current and/or potential commercialization of a category of searches in a search engine, the apparatus comprising:
means for measuring two or more of the metrics from the group consisting of:
number of searches within the category;
number of searches within the category that result in results pages having sponsored search results;
number of total advertisers in the category;
average number of sponsored search listings for results pages in the category;
click-through rate for advertisements in the category;
share of sponsored search results that are clicked versus other items that are clicked on results pages in the category;
average price per click on a sponsored search result advertisement in the category; and
lifetime value of users who perform searches within the category;
means for calculating a search category commercialization index (SCCI) for the category based on the two or more measured metrics; and
means for comparing the SCCI for the category against SCCIs from one or more other categories of searches in the search engine.

14. The apparatus of claim 13, wherein number of searches within the category is the total number of searches within the category over a designated period of time.

15. The apparatus of claim 13, wherein number of searches within the category that result in results pages having sponsored search results is calculated irrespective of duplicate searches.

16. The apparatus of claim 13, wherein click-through rate for advertisements in the category is a weighted average of click-though rates for advertisements in the category, wherein advertisements in prominent positions on results pages are weighted heavier than advertisements in less prominent positions.

17. The apparatus of claim 13, wherein the means for calculating includes means for applying a weight to each of the two or more measured metrics.

18. The apparatus of claim 13, further comprising:
means for plotting a graph, wherein a first axis of the graph represents volume of searches within a particular category and a second axis of the graph represents the SCCI for a particular category.

19. A program storage device readable by a machine, tangibly embodying a program of instructions executable by the machine to perform a method for determining the current and/or potential commercialization of a category of searches in a search engine, the method comprising:
measuring two or more of the metrics from the group consisting of:
number of searches within the category;
number of searches within the category that result in results pages having sponsored search results;
number of total advertisers in the category;
average number of sponsored search listings for results pages in the category;
click-through rate for advertisements in the category;
share of sponsored search results that are clicked versus other items that are clicked on results pages in the category;
average price per click on a sponsored search result advertisement in the category; and
lifetime value of users who perform searches within the category;
calculating a search category commercialization index (SCCI) for the category based on the two or more measured metrics; and
comparing the SCCI for the category against SCCIs from one or more other categories of searches in the search engine.
